(19) United States
(12) Patent Application Publication
(10) Pub. No.: US 2004/0247114 A1
(43) Pub. Date: Dec. 9, 2004

(54) Universal calculation method applied to points on an elliptical curve

(76) Inventor: Marc Joye, Saint Zacharie (FR)

Correspondence Address: BURNS DOANE SWECKER & MATHIS L L P, POST OFFICE BOX 1404, ALEXANDRIA, VA, 22313-1404, US

(21) Appl. No.: 10/486,974

(22) PCT Filed: Jul. 31, 2002
(86) PCT No.: PCT/FR02/02769

(30) Foreign Application Priority Data
Aug. 17, 2001 (FR) 01/10873

(51) Int. Cl. H04K 1/00

(52) U.S. Cl. 380/28

(57) ABSTRACT

The invention relates to a universal calculation method that is applied to points on an elliptical curve which is defined by a Weierstrass equation. According to the invention, identical programmed computing means are used to perform an operation involving the addition of points and an operation involving the doubling of points. The computing means comprise, in particular, a central unit which is connected to a storage unit. Said invention can be used for cryptographic calculations, for example in a chip card

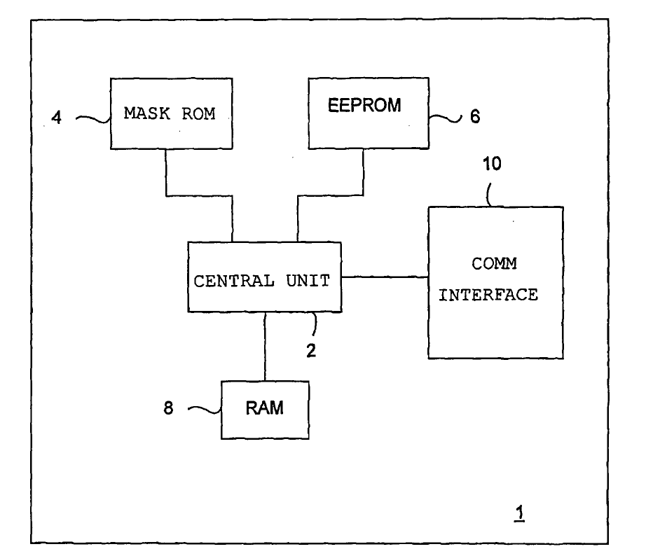

The present invention concerns a universal calculation method applied to points on an elliptic curve, and an electronic component comprising means of implementing such a method. The invention is in particular applicable to the implementation of cryptographic algorithms of the public key type, for example in chip cards.

Public key algorithms on an elliptic curve allow cryptographic applications of the enciphering, digital signature, authentication etc type.

They are in particular very much used in applications of the chip card type, since they make it possible to use short keys allowing fairly short processing times, and because they may not require the use of cryptoprocessors for their implementation, which reduces the cost price of the electronic components in which they are implemented.

There exist various parameterisations for defining an elliptic curve applicable in cryptography. One parameterisation frequently used is the so-called Weierstrass parameterisation. It should however be noted that Weierstrass parameterisation is very general since any elliptic curve can come under this parameterisation.

For the record, if IK is a field, all the points (X, Y) εIkxIK satisfying the general Weierstrass equation (Formula F1):

E/IK: Y²+a1xXxY+a3xY=X³+a2xX²+a4xX+a6

with ai εIK, and the point at infinity ο, form an elliptic curve E. Any elliptic curve on a field can be expressed in this form.

All the points (X, Y) and the point at infinity ο form an Abelian group in which the point at infinity ο is the neutral element and in which the group operation is the addition of points, denoted + and given by the well known secant and tangent rule. In this group, the pair (X, Y) where the X axis and the Y axis are elements of the field IK, form the affine coordinates of a point P on the elliptic curve.

The point P represented by the pair (X, Y) in affine coordinates can also be represented by projective coordinates of the general form (U, V, W).

The projective coordinates are in particular interesting in the exponentiation calculations applied to points on an elliptic curve, since they do not include any inversion calculations in the field.

The point P can be represented by so-called Jacobi projective coordinates of the general form (U, V, W) (X, Y) and (U, V, W) being linked by the following equations:

X=U/W2 and Y=V/W³ (Formulae F2)

With these Jacobi coordinates, the Weierstrass equation of an elliptic curve becomes:

E/IK: V²+a1UVW+a3VW³=U³+a2U²W²+a4UW⁴+a6W⁶.

The point P can also be represented by so-called homogeneous projective coordinates of the general form (U, V, W), (X, Y) and (U, V, W) this time being linked by the equations:

X=U/W and Y=V/W (Formulae F3)

With these homogeneous coordinates, the Weierstrass equation of an elliptic curve becomes:

E/IK: V²W +a1UVW+a3VW³=U³+a2U²W²+a4UW⁴+a6W⁶ (Formula F4)

The Weierstrass equation can be put in a simplified form according to the characteristic of the volume which the curve has defined. It should be stated that, in a finite field, the number of elements of the field is always expressed in the form pⁿ, where p is a prime number. p is the characteristic of the field. If the field is not finite, the characteristic is by convention defined as being equal to zero.

In the case where the characteristic of the field is different from 2 and 3, the Weierstrass equation, in affine coordinates, is simplified as follows:

E/IK: Y²=X³+axX+b (Formula F5)

where a and b are parameters of the elliptic curve, elements of IK.

From this simplified equation in affine coordinates there are of course derived equivalent formulations in the case of a Weierstrass parameterisation in projective, Jacobi or homogeneous coordinates.

Where the characteristic of the field is equal to 2, the Weierstrass equation of a non-supersingular curve, in affine coordinates, is simplified as follows:

E/IK: Y²+XY=X³+axX²+b (Formula F6)

where a and b are parameters of the elliptic curve, elements of IK.

From this simplified equation in affine coordinates there are of course derived as before equivalent formulations in the case of a Weierstrass parameterisation in projective, Jacobi or homogeneous coordinates.

According to the parameterisation which defines the elliptic curve and according to the coordinates with which the work is carried out, various addition, subtraction and doubling of points formulae are applicable. These formulae are given in numerous references known to persons skilled in the art. It should also be noted that, in the case of projective coordinates, the formulae are not unique since, as shown by formulae F2 and F3, a point in affine coordinates has several equivalent projective representations.

In the example of an elliptic curve E given by a Weierstrass parameterisation in affine coordinates, these formulae are as follows.

The inverse of a point P1=(X1, Y1) of this curve is the point −P1 of coordinates (X1, \overline{Y}1), with

\overline{Y}1=−Y1−a1xX1−a3 (Formula F11)

The operation of addition of the points P1 of coordinates (X1, Y1) and P2 of coordinates (X2, Y2) of this curve, with P1≠−P2, gives a point P3=P1+P2, of coordinates (X3, Y3) such that:

X3=λ²+a1xλ−a2−X1−X2 (Formula F12)

Y3=−(λ+a1)xX3−μ−a3 (Formula F13)

with

λ=(Y1−Y2)/(X1−X2), if X1≠X2 (Formula F14)

λ=(3X1²+2xa2xX1+a4−a1xY1)/(2Y1+a1xX1+a3)

if X1=X2 (Formula F15)

and μ=Y1−λxX1 (Formula F16)

Formula F14 is the formula of addition of two distinct points: P3=P1+P2, whilst formula F15 is the formula of doubling of the point: P3=2×P1.

From these equations in affine coordinates there are of course derived equivalent formulations in projective, Jacobi or homogeneous coordinates.

In the example of an elliptic curve E given by a Weierstrass parameterisation on a field with a characteristic different from 2 and 3, the addition, subtraction and doubling of points formulae are simplified since the equation of the curve itself is reduced. a1=a2=a3=0, a4=a and a5=b are posed.

In the case of a Weierstrass parameterisation in affine coordinates, the simplified addition, subtraction and doubling of points formulae are then as follows.

The inverse of a point P1=(X1, Y1) of the curve E is the point −P1=(X1, \overline{Y}1) with

\overline{Y}1=−Y1 (Formula F17)

The operation of addition of the points P1 of coordinates (X1, Y1) and P2 of coordinates (X2, Y2) of this curve, with P1≠P2, gives the point P3=P1+P2 whose coordinates (X3, Y3) are such that:

X3=λ²−X1−X2

Y3=λx(X1−X3)−Y1

with

λ=(Y1−Y2)/(X1−X2), if P1≠P2 (Formula 18)

λ=(3xX1²+a)/(2xY1), if P1=P2 (Formula 19)

Formula 18 is the formula of addition of two distinct points: P3=P1+P2, whilst Formula 19 is the formula of doubling of the point: P3=2×P1.

The simplified formulae of addition and doubling of points on a non-supersingular elliptic curve defined on a field of characteristic 2 is obtained in a similar fashion from the general formulae (Formulae F12 to F16) by posing a1=1, a3=a4=0, a2=a and a6=b.

The operations of addition or subtraction and doubling of a point are the basic operations used in exponentiation algorithms on elliptic curves: given a point P1 belonging to an elliptic curve E and d a predetermined number (an integer), the result of the scalar multiplication of the point P1 by the number d is a point P2 on the curve E such that P2=dxP1 =P1+P1+. . . +P1, d times. Public key cryptographic algorithms on an elliptic curve are thus based on the scalar multiplication of a point P1 selected on the curve, by a predetermined number d, a secret key. The result of this scalar multiplication dxP1 is a point P2 on the elliptic curve. In an example of application to enciphering according to the El Gamal method, the point P2 obtained is the public key which serves for the enciphering of a message.

The calculation of this scalar multiplication P2=dxP1 can be carried out by various algorithms. A few of these can be cited, such as the doubling and addition algorithm (double and add in the English literature) based on the binary representation of the exponent d, the addition-subtraction algorithm based on the signed binary representation of the exponent d, the window algorithm etc. All these algorithms use the addition, subtraction and doubling formulae defined on elliptic curves.

However, these algorithms prove sensitive to attacks aimed at discovering in particular the value of the secret key. It is possible in particular to cite concealed channel attacks, simple or differential. Simple or differential concealed channel attack means an attack based on a physical quantity measurable from outside the device and where direct analysis (simple attack) or analysis according to a statistical method (differential attack) makes it possible to discover information contained and manipulated in processings in the device. These attacks can thus make it possible to discover confidential information. These attacks were in particular revealed by Paul Kocher (Advances in Cryptology—CRYPTO'99, Vol. 1666 of Lecture Notes in Computer Science, pp. 388-397, Springer-Verlag, 1999). Amongst the physical quantities which can be exploited for these purposes are the execution time, the current consumption, the electromagnetic field radiated by the part of the component used for executing the calculation, etc. These attacks are based on the fact that the manipulation of a bit, that is to say its processing by means of a particular instruction, has a particular impression on the physical quantity in question according to the value of this bit and/or according to the instruction.

In the cryptographic systems based on elliptic curves, these attacks relate to scalar multiplication.

If the example is taken of a scalar multiplication algorithm on elliptic curves with the Weierstrass parameterisation, this algorithm may be susceptible to concealed channel attacks of the simple type, since the basic operations of doubling and addition are substantially different, as shown by the calculation of the lambda in Formulae F14 and F15 or F18 and F19 above.

It is therefore necessary to provide countermeasure methods for preventing the various attacks from prospering. In other words, it is necessary to make the scalar multiplication algorithms secure.

One object of the invention is to implement a universal calculation method, and more generally a cryptographic method, on elliptic curves, protected against concealed channel attacks.

With this objective in view, the object of the invention is a universal calculation method on points of an elliptic curve defined by a Weierstrass equation. According to the invention, identical programmed calculation means are used for performing an operation of addition of points and an operation of doubling of points. The calculation means comprise in particular a central unit and a memory.

Thus, with the invention, the basic operations of doubling an addition of points on an elliptic curve are identical, carried out by identical calculation means, and have the same formulation. It is therefore no longer possible to distinguish them, in particular in the context of simple concealed channel attacks. Consequently a universal calculation method according to the invention is protected against such attacks.

More generally, a scalar multiplication method applied to points on an elliptic curve or a cryptographic method on an elliptic curve using a universal calculation method according to the invention are protected in the same way.

This is true whatever the coordinates used for performing the calculations: affine, projective, Jacobi or homogeneous etc coordinates. Thus a single lambda value is used for performing an addition or a doubling of points.

According to a general embodiment, in order to perform the addition of a first point P1 defined by first affine coordinates (X1, Y1) and a second point P2 defined by second affine coordinates (X2, Y2), the affine coordinates of the first point P1 and those of the second point P2 being stored in first and second registers of the memory, the first point and the second point belonging to an elliptic curve defined by a Weierstrass equation of the type:

Y²+a1xXxY+a3xY=X³+a2xX²+a4xX+a6

(X, Y) being affine coordinates of a point on the curve, and a1, a2, a3, a4, a5, a6 being parameters of the elliptic curve,

the programmed calculation means calculate third affine coordinates (X3, Y3) defining a third point P3, the result of the addition, by means of the following equations:

X3=λ²+a1xλ−a2−X1−X2 (Formula F12)

Y3=−(λ+a1)xX3−μ−a3 (Formula F13)

with

λ=(X1²+X1xX2+X2²+a2xX1+a2xX2+a4−a1xY1)/(Y1+Y2+a1xX2+a3) (Formula F20)

μ=Y1−λxX1 (Formula F16)

the second point being different from the inverse (−P1) of the first point P1 and the second point being equal to or different from the first point,

and then store the third affine coordinates (X3, Y3) in the third registers of the memory.

The λ equation defined by Formula F20 is identical to the λ equation of the prior art defined by Formula F14, in the case where X1≠X2, that is to say in the case where P1≠P2 (the case of a veritable addition of two distinct points). In the same way the λ equation defined by Formula F20 is identical to the λ equation of the prior art defined by Formula F15, in the case where X1=X2 (the case of an operation of doubling of a point), that is to say in the case where P1=P2 doubling of a point). This will be shown more precisely below in one example.

The same lambda value thus makes it possible to perform an addition or doubling of points in the case of an elliptic curve defined by a Weierstrass parameterisation.

According to another embodiment, in order to perform the addition of the first point P1 defined by the first affine coordinates (X1, Y1) and the second point P2 defined by the second affine coordinates (X2, Y2), the affine coordinates of the first point P1 and those of the second point P2 being stored in the first and second registers of the memory, the first point and the second point belonging to an elliptic curve over a field with a characteristic different from 2 or 3, defined by a simplified Weierstrass equation of the type:

Y²=X³+axX+b

(X, Y) being af fine coordinates of a point on the curve, and a, b being parameters of the elliptic curve,

the programmed calculation means calculate the third affine coordinates (X3, Y3) defining the third point P3, the result of the addition, by means of the following equations:

X3=λ²−X1−X2

Y3=λx(X1−X3)−Y1

with:

λ=(X1²+X1xX2+X2²+a)/(Y1+Y2) (Formula F21)

the second point being different from the inverse (−P1) of the first point P1 and the second point being equal to or different from the first point,

and then store the third af f ine coordinates (X3, Y3) in the third registers of the memory.

Here too, the same value of lambda makes it possible to perform an addition or doubling of points in the case of an elliptic curve over a field with a characteristic different from 2 and 3 and defined by a simplified Weierstrass parameterisation.

According to another embodiment also, in order to perform the addition of the first point P1 defined by the first affine coordinates (X1, Y1) and the second point P2 defined by the second affine coordinates (X2, Y2), the affine coordinates of the first point P1 and those of the second point P2 being stored in the first and second registers of the memory (6, 8), the first point and the second point belonging to a non- supersingular elliptic curve over a field with a characteristic equal to 2, defined by a simplified Weierstrass equation of the type:

Y²+XY=X³+axX²+b,

(X, Y) being affine coordinates of a point on the curve, and a, b being parameters of the elliptic curve,

the programmed calculation means calculate the. third affine coordinates (X3, Y3) defining the third point P3, the result of the addition, by means of the following equations:

X3=λ²+λ+a +X1+X2

Y3=λx(X1+X3)+X3+Y1

with:

λ=(X1²30 X1xX2+X2²+aX1+aX2+Y1)/(Y1+Y2+X2) (Formula F22)

the second point being different from the inverse (−P1) of the first point P1 and the second point being equal to or different from the first point,

and then store the third af f ine coordinates (X3, Y3) in the third registers of the memory.

Here too, the same lambda value makes it possible to perform an addition or a doubling of points in the case of a non-supersingular elliptic curve over a field with a characteristic equal to 2.

As has just been seen, the calculation method according to the invention makes it possible to perform operations of addition or doubling of points belonging to elliptic curves, using the same formulation.

More generally, the method according to the invention can be used in a global scalar multiplication calculation method applied to points on an elliptic curve and/or in a cryptographic method.

Another object of the invention is an electronic component comprising programmed calculation means, comprising in particular a central unit and a memory, for implementing a universal calculation method for performing an addition or doubling of points on an elliptic curve as described above. The said electronic component can comprise means of global use of a cryptographic algorithm using a universal calculation method as described above.

Finally, another object of the invention is a chip card comprising an electronic component as described above.

The invention and the advantages which stem from it will emerge more clearly from a reading of the following description of particular example embodiments of the invention, given purely for indication purposes and with reference to the single accompanying figure. The latter shows, in block diagram form, an electronic device 1 able to perform cryptographic calculations.

In the following examples, the device 1 is a chip card intended to execute a cryptographic program. To this end, the device 1 combines in a chip card programmed calculation means, composed of a central unit 2 functionally connected to a set of memories including:

a memory 4 accessible solely in read mode, in the example of the mask ROM type, also known by the English term “mask read only memory (mask ROM)”,

an electrically reprogrammable memory 6, in the example of the EEPROM type (from the English “electrically erasable programmable ROM”), and

a working memory 8 accessible in read and write mode, in the example of the RAM type (from the English “random access memory”). This memory comprises in particular calculation registers used by the device 1.

The executable code corresponding to the exponentiation algorithm is contained in the program memory. This code can in practice be contained in the memory 4, accessible solely in read mode, and/or in the memory 6, which is rewritable.

The central unit 2 is connected to a communication interface 10 which provides the exchange of signals vis-à-vis the outside and the supply to the chip. This interface can comprise pins on the card for a so-called “contact” connection with a reader, and/or an antenna in the case of a so-called “contactless” card.

One of the functions of the device 1 is to encipher or decipher a confidential message M respectively transmitted to or received from the outside. This message can concern for example personal codes, medical information, compatibility with regard to banking or commercial transactions, authorisations for access to certain restricted services, etc. Another function is to calculate or verify a digital signal.

In order to fulfil these functions, the central unit 2 executes a cryptographic algorithm on programming data which are stored in the mask ROM 4 and/or EEPROM 6 parts.

The algorithm used here is a public key algorithm on an elliptic curve in the context of a Weierstrass parameterisation. The concern is more precisely here with part of this algorithm, which makes it possible to perform basic operations, that is to say operations of addition or doubling of points, in affine coordinates.

In a first example, the elliptic curve is a curve on a field with a characteristic strictly greater than 3, the equation of which is, with a, b ? IK:

E/IK: Y²=X³+axX+b

When the exponentiation calculation device 1 is acted on by the calculation of an addition operation, the central unit 2 first of all stores coordinates (X1, Y1), (X2, Y2) of two points P1, P2 of the elliptic curve, to be added. It is assumed here that the point P2 is different from the point (−P1) which is the inverse of the point P1.

The central unit 2 next calculates an intermediate variable λ according to the equation:

λ=(X1²+X1xX2+X2²+a)/(Y1+Y2) (Formula F21)

The central unit stores the variable λ in a register of the working memory 8 and then next calculates the coordinates (X3, Y3) of the point P3, the result of the addition of the point P1 and the point P2:

X3=λ²X1−X2

Y3=λx(X1−X3)−Y1

The coordinates (X3, Y3) are finally stored in the other registers of the working memory 8, in order to be used elsewhere, for example for the remainder of the enciphering algorithm.

In this example also, the λ equation defined by Formula F21 is identical to the λ equation of the prior art defined by the Formula F18, in the case where X1≢X2, that is to say in the case where P1 ≢P2 (the case of a veritable addition of distinct points).

This is because, starting from Equation F18, λ=(Y1−Y2)/(X1−X2), if X1 ≢X2, that is to say:

$$\begin{matrix}λ = ( Y1 - Y2 ) / ( X1 - X2 ) \\ = [ ( Y1 - Y2 ) ( Y1 - \overline{Y} 2 ) ] / [ ( X1 - X2 ) ( Y1 - \overline{Y} 2 ) ] \\ = ( {Y1}^{2} - {Y2}^{2} ) / [ ( X1 - X2 ) ( Y1 + Y2 ) ]\end{matrix}$$

since \overline{Y}2=−Y2 (Formula F17) in this example, there is derived from this:

λ=(X1³+axX1−X2³−axX2)/[(X1−X2)(Y1+Y2)]

since Yi²=Xi³+axXi+b for a point Pi on the elliptic curve considered in this example, the point Pi having the coordinates (Xi, Yi). This thus gives:

λ=(X1²+X1xX2+X2²+a)/(Y1+Y2),

that is to say Formula F21.

In the same way, the λ equation defined by Formula F21 is identical to the λ equation of the prior art defined by Formula F19, in the case where X1=X2 (the case of an operation of doubling a point), that is to say in the case where P1=P2. This is because, starting from Formula F21, taking X1=X2 and Y1=Y2, this immediately gives:

λ=(3xX1²+a)/(2xY1) (Formula F16)

The same lambda value thus makes it possible to perform an addition or a doubling of points in the case of an elliptic curve with a characteristic strictly greater than 3 and defined by a simplified Weierstrass parameterisation.

In a second example, the elliptic curve is a non- supersingular curve over a field with a characteristic of 2, whose equation, with a, b ? IK, is:

E/IK: Y²+Xy=X³+axX²+b

Just as in the previous example, when the exponentiation calculation device 1 is acted on for the calculation of an addition operation, the central unit 2 first of all stores the coordinates (X1, Y1), (X2, Y2) of two points P1, P2 to be added. It is assumed there also that the point P2 is different from a point (−P1) which is the inverse of the point P1.

The central unit 2 next calculates an intermediate variable λ according to the equation:

λ=(X1²30 X1xX2+X2²+aX1+aX2+Y1)/(Y1+Y2+X2) (Formula F21)

The central unit stores the variable λ in a register of the working memory 8 and then next calculates the coordinates (X3, Y3) of the point P3, the result of the addition of the point P1 and the point P2:

X3=λ²+λ+a+X1+X2

Y3=λx(X1+X3)+X3+Y1

The coordinates (X3, Y3) are finally stored in other registers of the working memory 8, in order to be used elsewhere.

In this example also, the λ equation defined by Formula F21 is identical to the λ equation of the prior art defined by Formula F18, in the case where X1≠X2, that is to say in the case where P1≠P2 (the case of a veritable addition of distinct points).

The same lambda value also makes it possible to perform an addition or doubling of points in the case of an elliptic curve with a characteristic equal to 2 and defined by a Weierstrass parameterisation.

It should be noted that in all the examples described above affine coordinates have been used. It is however entirely possible to use projective, homogeneous or Jacobi coordinates. It will simply be ensured where applicable that the formulae are rewritten in projective form.

For this purpose, in the λ formulae of X3 and Y3 given as an example, the affine coordinates Xi, Yi will be replaced by:

in Jacobi projective coordinates:

Xi=Ui/Wi² and Yi=Vi/Wi³,

in homogeneous projective coordinates:

Xi=Ui/Wi and Yi=Vi/Wi.

1. A cryptographic method during which universal calculation operations are performed on points on an elliptic curve defined by a Weierstrass equation, wherein identical programmed calculation means are used for performing an operation of addition of points and an operation of doubling of points, the calculation means comprising in particular a central unit associated with a memory.

2. A method according to claim 1, wherein, in order to perform the addition of a first point P1 defined by first affine coordinates (X1, Y1) and a second point P2 defined by second affine coordinates (X2, Y2), the affine coordinates of the first point P1 and those of the second point P2 being stored in first and second registers of the memory, the first point and the second point belonging to an elliptic curve defined by a Weierstrass equation of the type:
Y²+a1xXxY+a3xY=X³+a2xX²+a4xX+a6
(X, Y) being affine coordinates of a point on the curve, and a1, a2, a3, a4, a5, a6 being parameters of the elliptic curve,
the programmed calculation means calculate third affine coordinates (X3, Y3) defining a third point P3, the result of the addition, by means of the following equations:
X3=λ²+a1xλ−a2−X1−X2
Y3=−(λ+a1)xX3−μ−a3
with
λ=(X1²+X1xX2+X2²+a2xX1+a2xX2+a4−a1xY1)/(Y1+Y2+a1xX2+a3)
μ=Y1−λxX1
the second point being different from the inverse (−P1) of the first point P1 and the second point being equal to or different from the first point,
and then store the third affine coordinates (X3, Y3) in the third registers of the memory.

3. A method according to claim 1, wherein, in order to perform the addition of the first point P1 defined by the first affine coordinates (X1, Y1) and the second point P2 defined by the second affine coordinates (X2, Y2), the affine coordinates of the first point P1 and those of the second point P2 being stored in the first and second registers of the memory, the first point and the second point belonging to an elliptic curve over a field with a characteristic different from 2 or 3, defined by a simplified Weierstrass equation of the type:
Y²=X³+axX+b,
(X, Y) being affine coordinates of a point on the curve, and a, b being parameters of the elliptic curve,
the programmed calculation means calculate the third affine coordinates (X3, Y3) defining the third point P3, the result of the addition, by means of the following equations:
X3=λ²−X1−X2
Y3=λx(X1−X3)−Y1
with:
=(X1²+X1xX2+X2²+a)/(Y1+Y2)
the second point being different from the inverse (−P1) of the first point P1 and the second point being equal to or different from the first point,
and then store the third affine coordinates (X3, Y3) in the third registers of the memory.

4. A method according to claim 1, wherein in order to perform the addition of the first point P1 defined by the first affine coordinates (X1, Y1) and the second point P2 defined by the second affine coordinates (X2, Y2), the affine coordinates of the first point P1 and those of the second point P2 being stored in the first and second registers of the memory, the first point and the second point belonging to a non-supersingular elliptic curve over a field with a characteristic different from 2 or 3, defined by a simplified Weierstrass equation of the type:
Y²+XY=X³+axX²+b,
(X, Y) being affine coordinates of a point on the curve, and a, b being parameters of the elliptic curve,
the programmed calculation means calculate the third affine coordinates (X3, Y3) defining the third point P3, the result of the addition, by means of the following equations:
X3=λ²+λ+a+X1+X2
Y3=λx(X1+X3)+X3+Y1
with:
λ=(X1²+X1xX2+X2²+aX1+aX2+Y1)/(Y1+Y2+X2)
the second point being different from the inverse (−P1) of the first point P1 and the second point being equal to or different from the first point,
and then store the third affine coordinates (X3, Y3) in the third registers of the memory.

5. A method according to claim 1, wherein the first point, the second point and the third point on the elliptic curve are defined by projective coordinates.

6. A method according to claim 5, wherein the first point, the second point and the third point on the elliptic curve are defined by Jacobi projective coordinates.

7. A method according to claim 5, wherein the first point, the second point and the third point on the elliptic curve are defined by homogeneous projective coordinates.

8. A method according to claim 1, during which a scalar multiplication operation applied to points on an elliptic curve is performed.

9. An electronic component comprising calculation means programmed to implement a method according to claim 1, the calculation means comprising in particular a central unit (2) associated with a memory.

10. An electronic component comprising means of implementing a cryptographic algorithm using a method according to claim 1.

11. A chip card comprising an electronic component according to claim 10.
